(19) United States
(12) Patent Application Publication
(10) Pub. No.: US 2010/0009145 A1
(43) Pub. Date: Jan. 14, 2010

(54) Lotion Gradient Ratio In Stack Of Wet Substrates

(76) Inventors: Joerg Mueller, Karben (DE); Cagda Akdag, Bad Soden am Taunus (DE); Gary Dean LaVon, Liberty Township, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/172,398

(22) Filed: Jul. 14, 2008

(51) Int. Cl. B32B 27/40; B32B 7/02; B65D 51/00

(52) U.S. Cl. 428/213; 428/523; 428/212; 442/59; 220/200

(57) ABSTRACT

A stack of substrates impregnated with a composition, the stack of substrates having a barrier layer disposed within. The barrier layer disposed within the stack of substrates results in improved lotion gradient ratio in the stack of substrates.

### FIELD OF THE INVENTION

The present invention relates to a stack of substrates impregnated with a composition, the stack of substrates having a barrier layer disposed within. The barrier layer disposed within the stack of substrates results in improved lotion gradient ratio in the stack of substrates.

### BACKGROUND OF THE INVENTION

Moisture management, specifically wetness distribution, can be quite challenging to achieve in stacks of substrates comprising a composition, specifically a lotion. While the wetness distribution is almost homogeneous when the substrates are produced, capillary forces, gravitational forces, evaporation and condensation can change this distribution and cause undesired effects on the product properties and lotion gradient ratio in the substrate stacks.

Lotion gradient impacts wetness perception, cleaning, and dispensing. Uniform wetness is a consumer requirement and failure to meet the expectation is generally captured through consumer comments. Consumers often complain of “dryness” in the stack of substrates, and this negative attribute is generally caused by a combination of dry upper-most substrates and uneven wetness throughout the stack.

A lotion or composition that may be used in a stack of substrates is a non-Newtonian, thixotropic fluid, meaning that the viscosity is no longer constant but varies with the shear stress. Apparent viscosity decreases with duration of stress. Moisture exchange with the environment (via effective packaging), retention (uniform wetness distribution within a stack) is dependent upon the balance of capillary, forced flow and gravity.

Gravity is always present and its negative impact on retention becomes more significant with increased stack height. Forced flow is introduced into our system via composition or lotion bars which saturate the substrate at commercial line speeds. This force induces flow from one side of the substrate to the other and therefore works against retaining fluid within the substrate. It becomes particularly relevant at the time of composition or lotion application and later dissipates with frictional losses.

Capillary action is present whenever the fiber surface is chemically compatible with the composition or lotion and in the presence of small passages where surface/mass effects predominate. This is case of a stack of substrates or wipes since they incorporate pores with radii much smaller than 1 mm. At equilibrium, this force can hold fluid within a structure. Both gravity and forced flow work against retention of fluid within the stack, but neither can be eliminated. Capillary action, on the contrary, favors fluid retention. Furthermore, it can be optimized through understanding and selection of composition or lotion and fiber chemistry.

The driving force for absorption of the composition or lotion into substrate as porous media is the capillary forces. The absorption mechanism is traditionally interpreted as a flow through a system of capillary tubes using standard capillary flow equations. The absorbing substrate is usually defined as a porous medium with interconnected pores of various sizes, where the flow is characterized by the existence of saturation gradient along the direction of flow.

A current problem with stacks of substrates, specifically stacks of wet wipes is that after storage of the stack of wipes, the composition or lotion tends to migrate towards the bottom of the stack. This results in a stack that has an uneven distribution of the composition or lotion on the individual wipes with the upper wipes often becoming too dry while the lower wipes become over saturated with lotion. Therefore, a need exists for a stack of substrates comprising a composition having an improved lotion gradient ratio.

### SUMMARY OF THE INVENTION

The invention relates to a stack of substrates impregnated with a composition, the stack of substrates having a barrier layer disposed within. The stack of substrates comprises at least two substrates, each of the substrates having a cross direction dimension and a machine direction dimension. The barrier layer disposed within the stack of substrates results in improved lotion gradient ratio in the stack of substrates through a reduction in lotion gradient. The barrier layer of the present invention may comprise an inert hydrophobic layer.

The present invention is further directed to a container comprising a container body comprising a wall, the wall defining an article-receiving cavity; an opening located within the wall; a stack of substrates impregnated with a composition, wherein the stack of substrates comprises at least two substrates, each of the substrates having a cross direction dimension and a machine direction dimension; and at least one barrier layer disposed within the stack of substrates.

### BRIEF DESCRIPTION OF THE DRAWINGS

FIG. 1 depicts embodiments of the stack of substrates and barrier layers disposed within the stack of substrates useful in the present invention.

FIG. 2 depicts data generated from barrier layers of varying dimensions.

FIG. 3 depicts data generated from barrier layers of varying materials.

FIG. 4 depicts data generated from barrier layers of varying insertion points.

FIG. 5 depicts data generated from barrier layers improving the lotion gradient ratio in a stack of substrates.

### DETAILED DESCRIPTION OF THE INVENTION

“Basis Weight” refers herein to the weight (measured in grams) of a unit area (typically measured in square meters) of the fibrous structure, which unit area is taken in the plane of the fibrous structure. The size and shape of the unit area from which the basis weight is measured is dependent upon the relative and absolute sizes and shapes of the regions having different basis weights.

“Comprise,” “comprising,” and “comprises” are open ended terms, each specifies the presence of what follows, e.g., a component, but does not preclude the presence of other features, e.g., elements, steps, components known in the art, or disclosed herein.

“Cross Direction” refers herein to a direction that is perpendicular to the Machine Direction. This direction is carefully distinguished herein because the mechanical properties of fibrous structures can differ, depending on how the fibrous structure is oriented. For purposes herein, the Cross Direction is noted as having an angle of zero degrees in the X-Direction of an XY grid. All angles will be noted from the reference point of the Cross Direction.

“gsm” refers herein to “grams per square meter.”

“Machine Direction” refers herein to the direction in which a continuous fibrous structure is manufactured. Generally, fiber laying processes such as carding, spunbonding, melt-blowing, etc., may result in fiber-orientation parallel to the Machine Direction. This direction is carefully distinguished herein because the mechanical properties of fibrous structures can differ, depending on how the fibrous structure is oriented. For purposes herein, the Machine Direction is noted as having an angle of ninety degrees from the Cross Direction.

“Nonwoven” refers to a fibrous structure made from an assembly of continuous fibers, co-extruded fibers, non-continuous fibers and combinations thereof, without weaving or knitting, by processes such as spunbonding, carding, melt-blowing, air-laying, wet-laying, co-form, or other such processes known in the art for such purposes. The nonwoven structure may comprise one or more layers of such fibrous assemblies, wherein each layer may include continuous fibers, co-extruded fibers, non-continuous fibers and combinations thereof.

“Substrate” refers herein to a piece of material, generally non-woven material, used in cleaning or treating various surfaces, such as food, hard surfaces, inanimate objects, body parts, etc. For example, many currently available substrates may be intended for the cleansing of the peri-anal area after defecation. Other substrates may be available for the cleansing of the face or other body parts. A “substrate” may also be known as a “wipe” and both terms may be used interchangeably.

“Weight percent”, “%”, “percent”, “percent by weight” refers herein, when used in relation to material compositions, to the quantity by weight of a component as a percentage of the total, unless indicated otherwise.

Stacks of substrates, specifically stacks of wet wipes, are typically pre-moistened for ease in cleaning, disinfecting, and providing skin care benefits. Wetness distribution in a stack of substrates, specifically a stack of wet wipes, is based on a lotion gradient ratio (saturation at bottom/saturation at top of stack). The lotion gradient ratio is calculated by opening the stack of wet wipes and weighing every single wipe from the top of the substrate stack to the bottom of the substrate stack. For substrate stacks greater than 30 substrates per package, calculate the average lotion load of the last 10 wipes at the bottom of the stack and the first 10 wipes at the top of the stack. For substrate stacks including 30 substrates per package, calculate the average lotion load of the last 5 wipes at the bottom of the stack and the first 5 wipes at the top of the stack. For substrate stacks less than 30 substrates per package, calculate the average lotion load of the wipe at the bottom of the stack and the wipe at the top of the stack. Calculate the lotion gradient ratio by dividing the average lotion load per wipes from bottom by average lotion load per wipes from top. Where there is a lotion gradient through the stack of wipes, the ratio will be >1.

The ideal lotion gradient value is as close to 1 as possible, thus ensuring uniform lotion loading throughout the stack. Deviations from 1 are likely to generate consumer complaints for dryness.

Stacks of substrates, specifically stacks of wet wipes, described in the present invention are provided with an improved stacking configuration which comprises the insertion of at least one hydrophobic layer as a barrier layer within the stack to reduce lotion gradient ratio by blocking lotion distribution, particularly once the packaging has been closed. The hydrophobic layers are preferably liquid impermeable and are inserted in between the wipes throughout the stack. In this manner, the lotion gradient ratio can be significantly reduced.

Several variables can be considered when determining embodiments useful in the present invention. Specifically, the barrier layer may have varying dimensions, the barrier layer may be comprised of various materials, and the barrier layer may be inserted at varying positions in the stack of substrates.

Unless otherwise specified, experiments are conducted under standard laboratory conditions: temperature: 23° C.±2° C., relative humidity: 50-70%. Measurements for lotion load are determined by weighing the substrate before lotion loading then weighing the product after lotion loading; the difference is the lotion load.

### Barrier Layer Dimensions

The barrier layers of the present invention may be of any shape and/or size. The barrier layer may have a similar shape and/or size as the substrate in its folded configuration. In another embodiment, the barrier layers may have a shape and/or size that is greater than that of the folded substrate such that the barrier layers extend over the length and width of the folded substrates and therefore create an additional sealing effect along the side edges of the stack of substrates.

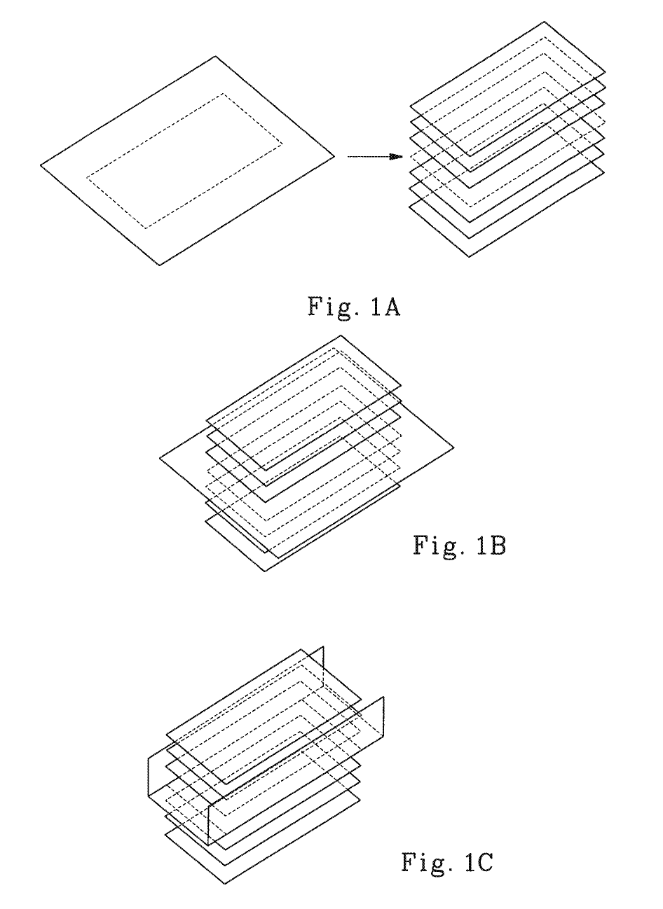

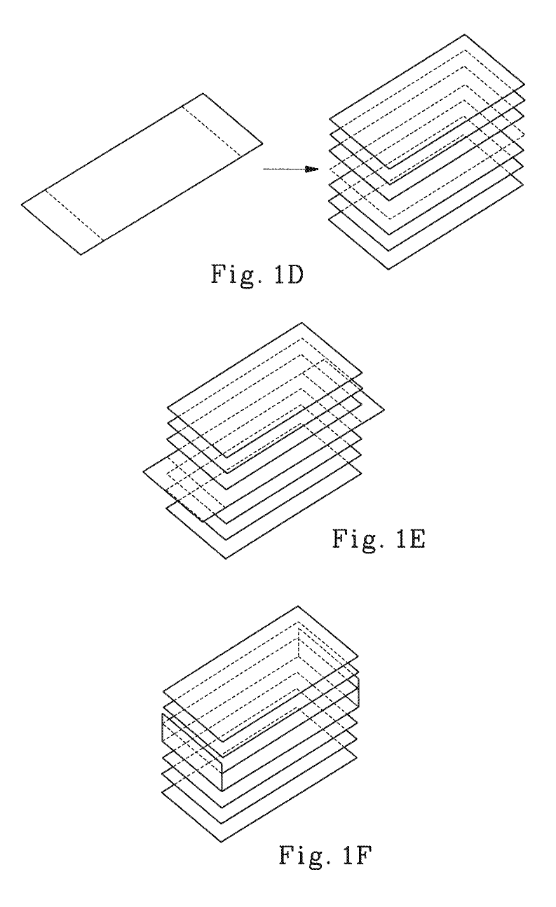

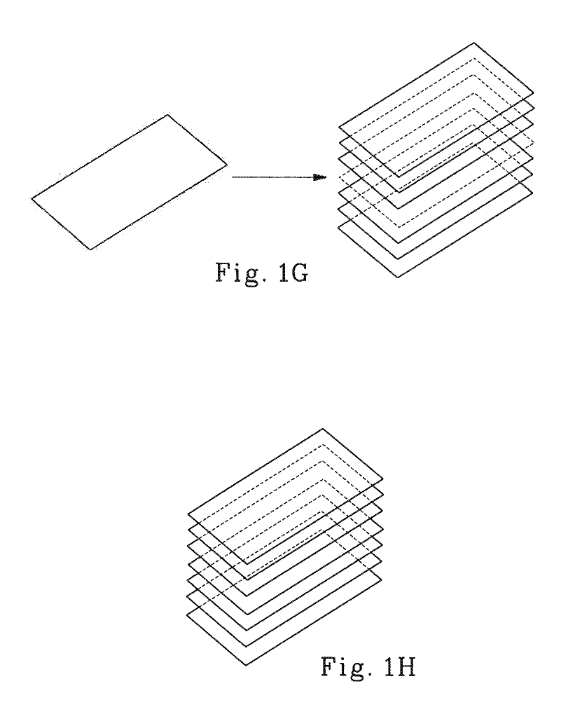

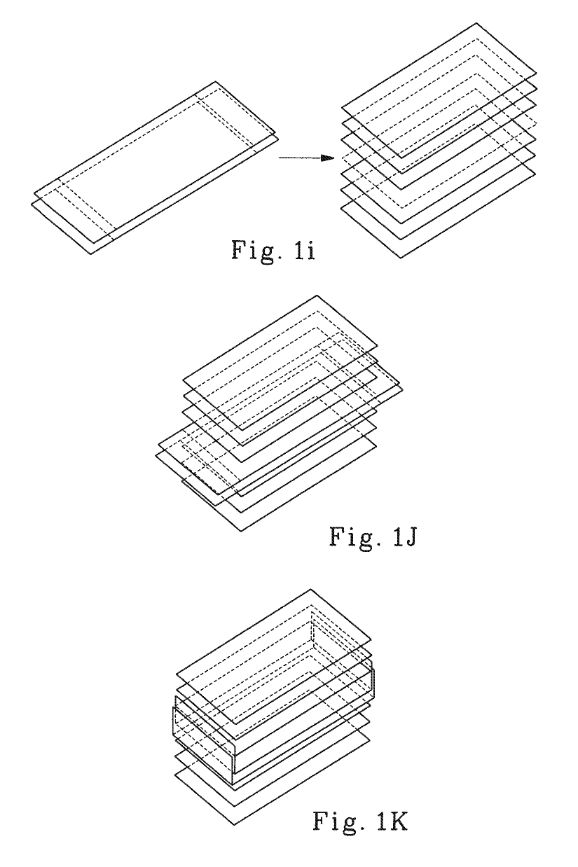

For example, consider a substrate when folded having dimensions of 10 cm in the cross direction (CD) and 16 cm in the machine direction (MD). The barrier layer may have greater dimensions in both the CD and the MD than the substrate (for example, the barrier layer may be 18 cm CD×20 cm MD); this will be referred to herein as Example A. The barrier layer may have the same dimensions in the CD as the substrate and greater dimensions in the MD than the substrate (for example, the barrier layer may be 10 cm CD×20 cm MD); this will be referred to herein as Example B. The barrier layer may have the same dimensions as the substrate (for example, the barrier layer may be 10 cm CD×16 cm MD); this will be referred to herein as Example C. The barrier layer may have the same dimensions in the CD as the substrate and greater dimensions in the MD than the substrate and be interleaved with the folded substrate in the longer MD (for example, the barrier layer may be 10 cm CD×20 cm MD and be interleaved with the folded substrate); this will be referred to herein as Example D. The constructions of Examples A, B, C, and D are shown in FIG. 1.

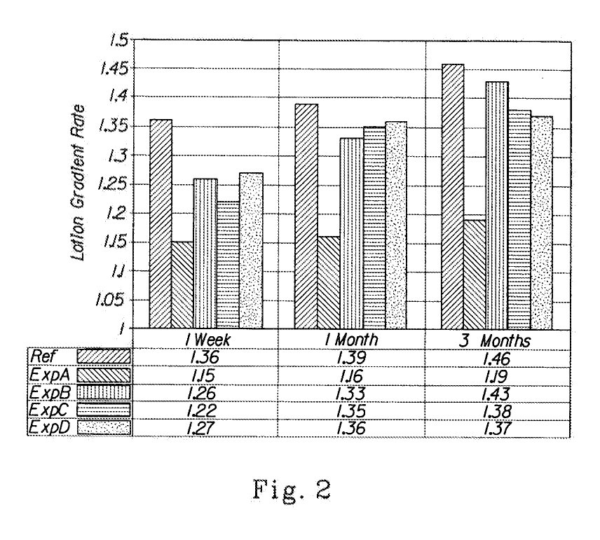

OPP/PET flow wrap may be used as the barrier layer material in Examples A, B, C, and D to understand the impact of varying the dimensions of the barrier layer on the lotion gradient rate. FIG. 2 depicts the lotion gradient rate in substrate stacks of a reference stack without barrier layer compared to Examples A, B, C, and D at 1 week, 1 month, and 3 months after production.

The data in FIG. 2 indicate that there is no significant difference between the lotion gradient rate of Example B, Example C and Example D, and these values are less than the lotion gradient rate of the reference stack without a barrier layer. Example A has a very different lotion gradient value than the other examples with 1.15 after 1 week, which is very close to the ideal value 1. Further, the lotion gradient rate increases for all examples and the reference stack more significantly than the rate in Example A. Thus, while inclusion of a barrier layer of any dimension may provide a benefit to lotion gradient rate, one embodiment useful in the present invention may include a barrier layer having longer dimensions in both the CD and the MD than the substrate.

### Barrier Layer Composition

The barrier layers of the present invention may be comprised of an inert layer. The barrier layers of the present invention may be comprised of a hydrophobic layer. In one embodiment, the barrier layer may comprise polypropylene and polyethylene. In one embodiment, the barrier layer may comprise an oriented polypropylene/polyethylene (OPP/PET) flow wrap. The OPP/PET flow wrap may be non-permeable. The OPP/PET flow wrap may be 100% hydrophobic. Flow wrap suitable for use in the present invention may include oriented polypropylene/polyethylene flow wrap, available from Amcor or Nordenia. In one embodiment, the barrier layer may comprise a silicon coated non-woven. Wet wipes lotion has very low surface tension range of 27-30 mN/m. A silicon coated non-woven may be useful in the present invention due to its barrier properties against low surface tension liquids. A silicon coated non-woven useful in the present invention is available from Pegas.

In addition, fluoro-treated non-wovens may be useful as a barrier layer in the present invention. Suitable fluoro-treated non-wovens are available from Pegas. Additional barrier layers that may be useful in the present invention are described in U.S. Pat. No. 6,413,344 and U.S. Pat. No. 6,488,801.

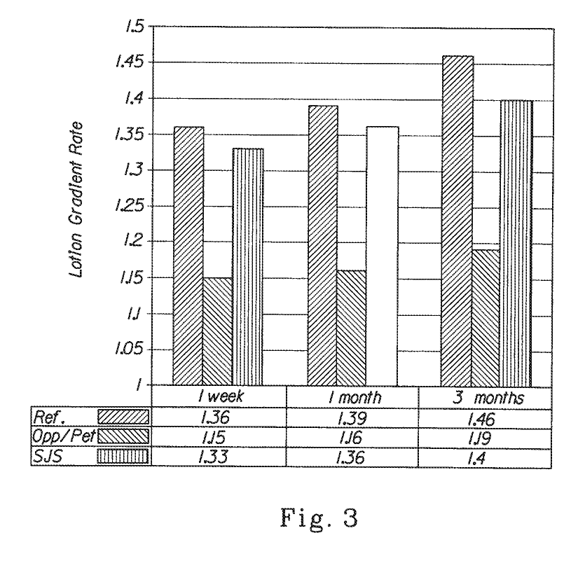

FIG. 3 illustrates the effect of material properties on the lotion gradient rate over time. FIG. 3 includes a reference stack without a barrier layer compared to a barrier layer comprised of OPP/PET flow wrap and a barrier layer comprised of a silicon coated non-woven at 1 week, 1 month, and 3 months after production. In this figure, the substrate has folded dimensions of 10 cm in the cross direction (CD) and 16 cm in the machine direction (MD). The barrier layer has longer dimensions in both the CD and the MD than the substrate (specifically, the barrier layer is 18 cm CD×20 cm MD).

As depicted in FIG. 3, the usage of the silicon coated non-woven slightly improves the lotion gradient rate as compared to the reference stack, but it does not change the lotion gradient rate significantly. Further, OPP/PET flow wrap improves the lotion gradient rate to be closer to the ideal value 1. Further, the OPP/PET flow wrap keeps the lotion gradient rate relatively constant over time in comparison to the reference stack without a barrier layer.

### Barrier Layer Insert Points

Further, the barrier layers of the present invention may be inserted within the stack at regular or irregular intervals. The ratio of substrates to barrier layer may be from about 3:1; from about 5:1; from about 7:1; from about 10:1; from about 15:1, from about 20:1; from about 25:1; from about 30:1; from about 31:1; from about 35:1; from about 40:1; from about 45:1; from about 50:1; from about 55:1; from about 60:1; from about 63:1; from about 65:1; from about 70:1. Further, the barrier layer may be inserted in about the middle of the stack of substrates. In one embodiment of the present invention, the barrier layer may be placed randomly throughout the stack.

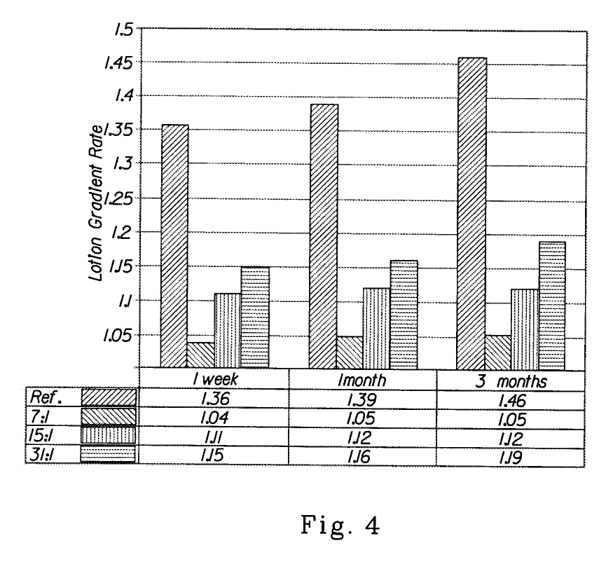

In one embodiment of the present invention, the stack may comprise 63 substrates. However, any size stack of substrates may be utilized in the present invention. FIG. 4 illustrates the effect of barrier layer insertion points on the lotion gradient rate over time. FIG. 4 includes a reference stack without a barrier layer compared to barrier layers inserted at different ratios. FIG. 4 shows a ratio of substrate to barrier layer of 7:1, 15:1 and 31:1 in a stack of 63 substrates at 1 week, 1 month, and 3 months after production. In this figure, the substrate has folded dimensions of 10 cm in the cross direction (CD) and 16 cm in the machine direction (MD). The barrier layer has longer dimensions in both the CD and the MD than the substrate (specifically, for this figure, the barrier layer is 18 cm CD×20 cm MD). The barrier layer is comprised of OPP/PET flow wrap.

FIG. 4 indicates that there is a benefit in having a barrier layer at any ratio to substrate as compared to the reference stack. This benefit is likely attributed to the effect of reducing the stack height. The ideal lotion gradient rate is nearly achieved by inserting the barrier layer in between every 7 substrates. However, FIG. 4 indicates that inclusion of a barrier layer at any ratio is beneficial to the lotion gradient rate.

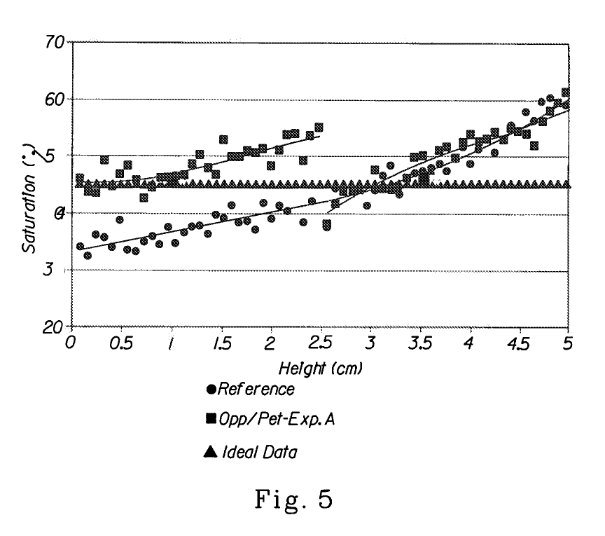

Thus, the data indicate that the presence of at least one barrier layer inserted in the substrate stack improves the lotion gradient ratio. FIG. 5 shows that the presence of just one barrier layer comprised of OPP/PET flow wrap, having dimension of 18 cm CD×20 cm MD, inserted in the middle of the stack, dividing the stack of substrates into two sub-stacks of substrates considerably reduces lotion gradient rate three months after production. In FIG. 5, the reference stack has a lotion gradient rate of 1.64; the barrier layer has a lotion gradient rate of 1.22, which is much closer to the ideal value 1.

In one embodiment of the present invention, substrates in the stack may be treated in order to provide at least a portion of the requisite barrier property. The treated substrates may be used alone or in addition to a separate barrier layer.

Further, in one embodiment of the present invention, the lotion gradient may undergo a step function, wherein the lotion gradient ratio increases moving from the top of the stack of substrates toward the bottom of the stack until reaching the barrier layer, at which point the lotion gradient undergoes a step function wherein the lotion gradient is lower but increases again until the next barrier layer and so on and so forth. This creates a step function resulting in a higher lotion gradient ratio in the substrate on the top side of the barrier layer and a lower lotion gradient ratio in the substrate on the bottom side of the barrier layer. The step function is similar to a wave; the amplitude of the wave, or size of the step, is a function of the spacing between the barrier layers for a substrate with a given capillary desorption pressure. In other words, the closer the barrier layers the smaller the wave or step and the more consistent the lotion load. Alternatively, the farther the barrier layers are spaced the greater the wave or step. The spacing can be optimized based on the capillary desorption pressure of the substrate to provide the optimum step function and consumer response.

For instance, for the sake of example, assume a stack of substrates comprising 20 substrates. If a barrier layer is inserted between substrates 10 and 11, the barrier will prevent the lotion gradient in substrate 10 from decreasing beyond a certain level. Further, the substrate below the barrier, for example, substrate 11, would become the first substrate in the second stack and would have less lotion than a substrate in the bottom of the stack, for example, substrate 20. Thus, the barrier layer in combination with gravity causes the step function gradient. Gravity causes the lotion gradient in stack 1, substrates 1-10, then the barrier stops the gradient and resets it for a second stack of substrates, substrates 11-20, and so on and so forth. Thus, substrates at the top of the stack (for example, substrates 1 and 11) will have a lower lotion gradient ratio than substrates at the bottom of the stack (for instance substrates 10 and 20).

The stack of substrates comprising a barrier layer of the present invention may have a lotion gradient value of less than about 1.35 at one week after production, less than about 1.30 at one week after production, less than about 1.25 at one week after production, less than about 1.20 at one week after production, less than about 1.15 at one week after production, less than about 1.10 at one week after production, less than about 1.05 at one week after production.

The stack of substrates comprising a barrier layer of the present invention may have a lotion gradient value of less than about 1.38 at one month after production, less than about 1.35 at one month after production, less than about 1.30 at one month after production, less than about 1.25 at one month after production, less than about 1.20 at one month after production, less than about 1.15 at one month after production, less than about 1.10 at one month after production.

The stack of substrates comprising a barrier layer of the present invention may have a lotion gradient value of less than about 1.45 at three months after production, less than about 1.40 at three months after production, less than about 1.30 at three months after production, less than about 1.25 at three months after production, less than about 1.20 at three months after production, less than about 1.15 at three months after production, less than about 1.10 at three months after production.

The barrier layers of the present invention may be any desirable color. It may be advantageous to provide barrier layers that differ in color from that of the substrates so that a consumer can readily identify the barrier layers from the substrates. However, the barrier layers may also be the same color as the substrate. Further, the barrier layers may be transparent in order to enable a consumer to determine whether or not there are substrates remaining in the package.

The barrier layers of the present invention may be contained in a container. Any container suitable for containing substrates may be used. The container of the present invention may comprise a container body comprising a wall defining an article-receiving cavity; an opening located within the wall; a stack of substrates impregnated with a composition, wherein the stack of substrates comprises at least two substrates, each of the substrates having a cross direction dimension and a machine direction dimension; and at least one barrier layer disposed within the stack of substrates.

### Substrate

Any substrate useful as a wet wipe may be used in the present invention. The substrate of the present invention may comprise a molded fibrous structure. The substrate may be formed by any process known in the art, including, but not limited to, slitting, cutting, perforating, folding, stacking, interleaving, lotioning, and combinations thereof.

The material of which a substrate is made from should be strong enough to resist tearing during manufacture and normal use, yet still provide softness to the user's skin, such as a child's tender skin. Additionally, the material should be at least capable of retaining its form for the duration of the user's cleansing experience.

The substrate may be woven or nonwoven, foam, or films. In one embodiment, the substrate is a nonwoven and may be comprised of natural or synthetic fibers, or mixtures thereof. The substrate may comprise fiber compositions that are a mix of hydrophilic fiber material such as viscose, cotton, or other natural and synthetic fibers and a hydrophobic fiber material such as polyethylene tetraphthalate (PET) or polypropylene (PP) in a ratio of from about 10% to about 90% hydrophilic and from about 90% to about 10% hydrophobic material by weight.

Substrates may be generally of sufficient dimension to allow for convenient handling. Typically, the substrate may be cut and/or folded to such dimensions as part of the manufacturing process. In some instances, the substrate may be cut into individual portions so as to provide separate wipes which are often stacked and interleaved in consumer packaging. In other embodiments, the substrates may be in a web form where the web has been slit and folded to a predetermined width and provided with means (e.g., perforations) to allow individual wipes to be separated from the web by a user. Suitably, the separate wipes may have a length between about 100 mm and about 250 mm and a width between about 140 mm and about 250 mm. In one embodiment, the separate wipe may be about 200 mm long and about 180 mm wide.

The material of the substrate may generally be soft and flexible, potentially having a structured surface to enhance its performance. It is also within the scope of the present invention that the substrate may include laminates of two or more materials. Commercially available laminates, or purposely built laminates would be within the scope of the present invention. The laminated materials may be joined or bonded together in any suitable fashion, such as, but not limited to, ultrasonic bonding, adhesive, glue, fusion bonding, heat bonding, thermal bonding, hydroentangling and combinations thereof. In another alternative embodiment of the present invention the substrate may be a laminate comprising one or more layers of nonwoven materials and one or more layers of film. Examples of such optional films, include, but are not limited to, polyolefin films, such as, polyethylene film. An illustrative, but non-limiting example of a nonwoven sheet member which is a laminate of a 16 gsm nonwoven polypropylene and a 0.8 mm 20 gsm polyethylene film.

The substrate materials may also be treated to improve the softness and texture thereof. The substrate may be subjected to various treatments, such as, but not limited to, physical treatment, such as ring rolling, as described in U.S. Pat. No. 5,143,679; structural elongation, as described in U.S. Pat. No. 5,518,801; consolidation, as described in U.S. Pat. Nos. 5,914,084, 6,114,263, 6,129,801 and 6,383,431; stretch aperturing, as described in U.S. Pat. Nos. 5,628,097, 5,658,639 and 5,916,661; differential elongation, as described in WO Publication No. 2003/0028165A1; and other solid state formation technologies as described in U.S. Publication No. 2004/0131820A1 and U.S. Publication No. 2004/0265534A1, zone activation, and the like; chemical treatment, such as, but not limited to, rendering part or all of the substrate hydrophobic, and/or hydrophilic, and the like; thermal treatment, such as, but not limited to, softening of fibers by heating, thermal bonding and the like; and combinations thereof.

The substrate may have a basis weight of at least about 30 grams/m². The substrate may have a basis weight of at least about 40 grams/m². In one embodiment, the substrate may have a basis weight of at least about 45 grams/m². In another embodiment, the substrate basis weight may be less than about 75 grams/m². In another embodiment, substrates may have a basis weight between about 40 grams/m² and about 75 grams/m², and in yet another embodiment a basis weight between about 40 grams/m² and about 65 grams/m². The substrate may have a basis weight between about 30, 40, or 45 and about 50, 55, 60, 65, 70 or 75 grams/m².

A suitable substrate may be a carded nonwoven comprising a 40/60 blend of viscose fibers and polypropylene fibers having a basis weight of 58 grams/m² as available from Suominen of Tampere, Finland as FIBRELLA 3160. Another suitable material for use as a substrate may be SAWATEX 2642 as available from Sandler AG of Schwarzenbach/Salle, Germany. Yet another suitable material for use as a substrate may have a basis weight of from about 50 grams/m² to about 60 grams/m² and have a 20/80 blend of viscose fibers and polypropylene fibers. The substrate may also be a 60/40 blend of pulp and viscose fibers. The substrate may also be formed from any of the following fibrous webs such as those available from the J.W. Suominen Company of Finland, and sold under the FIBRELLA trade name. For example, FIBRELLA 3100 is a 62 gsm nonwoven web comprising 50% 1.5 denier polypropylene fibers and 50% 1.5 denier viscose fibers. In both of these commercially available fibrous webs, the average fiber length is about 38 mm. Additional fibrous webs available from Suominen may include a 62 gsm nonwoven web comprising 60% polypropylene fibers and 40% viscose fibers; a fibrous web comprising a basis weight from about 50 or 55 to about 58 or 62 and comprising 60% polypropylene fibers and 40% viscose fibers; and a fibrous web comprising a basis weight from about 62 to about 70 or 75 gsm. The latter fibrous web may comprise 60% polypropylene fibers and 40% viscose fibers.

In one embodiment of the present invention the surface of substrate may be essentially flat. In another embodiment of the present invention the surface of the substrate may optionally contain raised and/or lowered portions. These can be in the form of logos, indicia, trademarks, geometric patterns, images of the surfaces that the substrate is intended to clean (i.e., infant's body, face, etc.). They may be randomly arranged on the surface of the substrate or be in a repetitive pattern of some form.

In another embodiment of the present invention the substrate may be biodegradable. For example, the substrate could be made from a biodegradable material such as a polyesteramide, or a high wet strength cellulose.

### Composition

The substrate of the present invention is generally impregnated with a composition such as a liquid or semi liquid cleaning lotion, intended to facilitate cleaning and/or provide a smooth feeling to the skin after use. Other ingredients or actives (for example cosmetic actives) can be part of the composition.

Generally the composition is of sufficiently low viscosity to disperse solid soils disposed on the skin and to facilitate impregnation of the entire structure of the wipe. In some other instances, the composition can be primarily present at the wipe surface and to a lesser extent in the inner structure of the wipe. Suitably the substrate is impregnated with at least about 2.0 times its weight with the cleaning lotion. In one embodiment, the wipe is impregnated with at least about 2.5 times its weight, with at least about 3.0 times its weight. Alternatively, impregnation to greater than about 6.0 times its weight is undesirable; in one embodiment, the substrate is impregnated to less than about 5.0 times its weight.

Desirably, the substrate releasably carries the cleaning lotion, that is, the composition is contained either in or on the substrate and is readily releasable from the substrate by applying a relatively low force to the substrate (e.g., wiping a surface, such as the skin in the perianal area, with the wet wipe).

The composition of the present invention may comprise an emollient; a particulate material, a surfactant and/or an emulsifier; a rheology modifier; and water. Other ingredients may be incorporated into the composition, including, but not limited to, soothing agents, botanicals, skin health agents and preservatives. It is to be noted that some compounds can have a multiple function and that all compounds are not necessarily present in the composition of the invention. In one embodiment, the cleaning composition of the present invention is an oil-in-water emulsion.

### Emollient

The emollient of the present invention may have a solubility parameter between about 5 and about 12, between about 5 and about 9. The emollient content of the composition may be from about 0.001% to less than about 5%, from about 0.001% to less than about 3%, from about 0.001% to less than about 2.5%, from about 0.001% to less than about 1.5%.

Emollients useful in the present invention may be silicon-based. Silicone-based emollients are organo-silicone-based polymers with repeating silioxane (Si—O) units. Silicone-based emollients of the present invention are hydrophobic and exist in a wide range of possible molecular weights. They include linear, cyclic and cross-linked varieties. Silicone oils are generally chemically inert and usually have a high flash point. Due to their low surface tension, silicone oils readily spread and have high surface activity. Examples of silicon oils suitable for use in the present invention include, but are not limited to: Cyclomethicones, Dimethicones, phenyl-modified silicones, alkyl-modified silicones, silicone resins, and combinations thereof. Other emollients useful in the present invention include unsaturated esters or fatty esters, such as ethyl, hexyl stearate or caprylic/capric triglycerides.

### Particulate Material

Compositions of the present invention may comprise a particulate material. The composition may comprise less than about 2.5% particulate material, less than about 1.5%, less than about 1.0%. The composition of the present invention may have a particulate concentration between about 0.01% and about 1.0%, between about 0.4% and about 0.6%.

Suitable commercially available particulate materials include but are not limited to: polyethylene powders are available from Honeywell International of Morristown, N.J. under the trade name ACUMIST; polymethyl methacrylate microspheres as are available from KOBO of South Plainfield, N.J. as BPA; lactone cross polymer microspheres as are available from KOBO as BPD; nylon 12 microspheres as are available from KOBO as NYLON SP; polymethylsilsesquioxane microspheres as are available from KOBO as TOSPEARL; cellulose microspheres as are available from KOBO as CELLO-BEADS; silica microspheres as are available from KOBO as MSS; polytetrafluoroethylene powders as are available from Micro Powders, Inc. of Tarrytown, N.Y. as MICROSLIP; micronized waxes as are available from Micro Powders as MICROEASE; blends of natural wax and micronized polymers as are available form Micro Powders as MICROCARE and microspherical particles of a copolymer of vinylidene chloride, acrylonitrile and methylmethacrylate available as EXPANCEL from Expancel, Inc. of Duluth, Ga. Useful in the present invention are polyolefin powders as are available from Equistar Chemical Corp. Houston, Tex. as MICROTHENE, MICROTHENE FN510-00 from Equistar.

### Emulsifier/Surfactant

The composition may comprise one or more emulsifiers as are known in the art for forming oil-in-water emulsions. Emulsifiers useful in the present invention may also perform well as a surfactant to aid in cleaning. Mixtures of emulsifiers and other surface active components may also be used. The emulsifier can be a polymeric emulsifier.

Emulsifiers useful in the present invention may include nonionic surfactants. Examples of nonionic surfactants are disclosed in McCutcheon's, Detergents and Emulsifiers, North American Edition (1997) and McCutcheon's, Functional Materials, North American Edition (1997) both published by Mc Publishing Co. of Glen Rock, N.J.

Nonionic surfactants useful herein include those selected from the group consisting of alkyl glycosides and alkyl polyglycosides. These can be broadly defined as a condensation product of a long chain alcohol, e.g. C₈-C₃₀ alcohols, with a sugar; a sugar polymer or a starch (i.e., a glycoside or a polyglycoside). These compounds can be represented by the formula (S)ₙ—O—R wherein S is a sugar moiety such as glucose, fructose, mannose, and galactose; n is an integer of from about 1 to about 1000, and R is a C₈-C₃₀ alkyl group. Non-limiting examples of an alkyl glycoside and an alkyl polyglycoside include polysorbate-20 and polysorbate-60.

Also useful are ethoxylated and propoxylated alcohol ethers; ethoxylated and propoxylated esters; and ethoxylated and propoxylated amides. These can be broadly defined as condensation products of long chain alcohols or carboxylic acids or amides, e.g. C₈-C₃₀ alcohols or C₈-C₃₀ carboxylic acids or C₈-C₃₀ carboxylic acid amides, with an alkoxide such as ethylene oxide and/or propylene oxide.

Also useful are ethoxylated and propoxylated mono-, di-, and tri-glycerides. These can be broadly defined as condensation products of long-chain carboxylic acids (e.g., C₈₋₃₀ carboxylic acids) with glycerin where either one or two or three carboxylic acid moieties are bound to the glycerin moiety. Non-limiting examples include PEG-40 hydrogenated castor oil from BASF of Ludwigshafen, Germany as Cremophor C-40 or PEG-6 Caprylic/Capric Glycerides from Sasol Germany GmbH of Witten, Germany as Softigen-767.

Also useful are silicone co-polyol surfactants. These can be broadly defined as condensation products of ethylene oxide and/or propylene oxide and poly-dimethylsiloxane. These materials can adopt a number of structures, including but not limited to linear structures, and pendant structures. Non-limiting examples include Bis-PEG/PPG-16/16 PEG/PPG-16/16 Dimethicone; Bis-PEG/PPG-20/20 PEG/PPG-20/20 Dimethicone; PEG/PPG-20/6 Dimethicone; and PEG/PPG-4/12 Dimethicone as are available from Degussa Care Specialties of Hopewell, Va. under the trade name ABIL and the silicone glycol copolymers as are available from GE Silicones of Wilton, Conn. under the trade name SILWET L.

Also suitable are glycerol esters and alkoxylated derivatives thereof. Exemplary materials include the glyceryl stearate blends available from Degussa Care Specialties of Hopewell, Va. under the name TEGO CARE.

Also useful are ionic surfactants including anionic surfactants, amphoteric surfactants and zwitterionic surfactants.

Also useful are emulsifiers such as alkylpolylglycosides (e.g., Polysorbate 20 available from Uniqema of New Castle, Del.) and a blend of caprylic capric triglyceride and bis-PEG/PPG-16/16 PEG/PPG-16/16 dimethicone (ABILCARE 85 from Degussa Care Specialties of Hopewell, Va.) and combinations thereof. ABILCARE 85 is useful in the present invention because heating the aqueous phase is not necessary for emulsion formation and because the blend also provides emollient functionality.

The composition may comprise less than about 3 percent of the nonionic surfactant; less than about 1 percent of the nonionic surfactant; between about 0.3 and about 0.6 percent by weight of the nonionic surfactant. In some instances compositions may comprise more than one emulsifier (i.e., an emulsifier and a co-emulsifier).

### Rheology Modifier

Rheology modifiers useful in the present invention include blends of material as are available from Uniqema GmbH&Co. KG, of Emmerich, Germany under the trade name ARLATONE. Useful in the present invention are ARLATONE V-175 which is a blend of Sucrose Palmitate, Glyceryl Stearate, Glyceryl Stearate Citrate, Sucrose, Mannan, and Xanthan Gum and ARLATONE V-100 which is a blend of Steareth-100, Steareth-2, Glyceryl Stearate Citrate, Sucrose, Mannan and Xanthan Gum; blends of materials as are available from Seppic France of Paris, France as SIMULGEL. Useful in the present invention are SIMULGEL NS which comprises a blend of a hydroxyethylacrylate/sodium acryloyldimethyl taurate copolymer with squalane and polysorbate 60 and SIMULGEL EPG which comprises a blend of a sodium acrylate/sodium acryloyldimethyltaurate copolymer with polyisobutene and caprylyl capryl glucoside; Acrylate homopolymers, acrylate crosspolymers, such as but not limited to Acrylate/C10-30 alkyl acrylate crosspolymers, carbomers, such as but not limited to acrylic acid cross linked with one or more allyl ether, such as but not limited to allyl ethers of pentaerythritol, allyl ethers of sucrose, allyl ethers of propylene, and combinations thereof as are available as the Carbopol® 900 series from Noveon, Inc. of Cleveland, Ohio (e.g., Carbopol® 954); Naturally occurring polymers such as xanthan gum, Galactoarabinan and other polysaccharides; Combinations of the above rheology modifiers.

Examples of commercially available rheology modifiers include, but are not limited to, Ultrez-10, a carbomer; Pemulen TR-2, an acrylate crosspolymer; both of which are available from Noveon, Cleveland Ohio and Keltrol, a xanthan gum, available from CP Kelco San Diego, Calif.

Rheology modifiers, when present may be used in the present invention at a weight/weight % (w/w) from about 0.01% to about 3%, from about 0.015% to about 2%, from about 0.02% to about 1%.

### Other Optional Components of the Composition

The composition of the present invention may optionally include an adjunct ingredient. The adjunct ingredient may include a wide range of additional ingredients such as, but not limited to perfumes, fragrances, preservatives, rheology modifiers, moisturizers, texturizers, colorants, medically active ingredients, in particular healing actives and skin protectants. Combinations of adjunct ingredients are also within the scope of the present invention.

Humectants are hygroscopic materials that function to draw water into the stratum corneum to hydrate the skin. The water may come from the dermis or from the atmosphere. Examples of humectants include glycerin, propylene glycol, and phospholipids.

Fragrance components, such as perfumes, include, but are not limited to water insoluble oils, including essential oils.

Preservatives prevent the growth of micro-organisms in the liquid lotion and/or on the substrate. Generally, such preservatives are hydrophobic or hydrophilic organic molecules. Suitable preservatives include, but are not limited to parabens, such as methyl parabens, propyl parabens, alkyl glycinates, iodine derivatives, quaternary ammonium salts (e.g., benzalkonium chloride) and combinations thereof. Preservative systems are disclosed in published US Pat. Application No. 2004/022158 and in U.S. patent application Ser. No. 10/878,875.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A stack of substrates comprising:
a. a stack of substrates impregnated with a composition, wherein said stack of substrates comprises at least two substrates, each of said at least two substrates having a cross direction dimension and a machine direction dimension; and
b. at least one barrier layer disposed within said stack of substrates.

2. The stack of substrates of claim 1 having a reduced lotion gradient.

3. The stack of substrates of claim 1, wherein said barrier layer is an inert hydrophobic layer.

4. The stack of substrates of claim 1, wherein said barrier layer is liquid impermeable.

5. The stack of substrates of claim 1, wherein said barrier layer comprises polypropylene and polyethylene.

6. The stack of substrates of claim 1, wherein said barrier layer is an oriented polypropylene/polyethylene flow wrap.

7. The stack of substrates of claim 1, wherein said barrier layer is a different color than said stack of substrates.

8. The stack of substrates of claim 1, wherein said barrier layer is transparent.

9. The stack of substrates of claim 1, wherein said barrier layer has a cross direction dimension that is greater than said cross direction dimension of said at least two substrates.

10. The stack of substrates of claim 1, wherein said barrier layer has a machine direction dimension that is greater than said machine direction dimension of said at least two substrates.

11. The stack of substrates of claim 1, wherein said barrier layer has a cross direction dimension that is greater than said cross direction dimension of said at least two substrates and a machine direction dimension that is greater than said machine direction dimension of said at least two substrates.

12. The stack of substrates of claim 1, wherein said barrier layer has a cross direction dimension of about 18 cm and a machine direction dimension of about 20 cm.

13. The stack of substrates of claim 1, having a substrate to barrier layer ratio of about 7:1.

14. The stack of substrates of claim 1, having a substrate to barrier layer ratio of about 15:1.

15. The stack of substrates of claim 1, having a substrate to barrier layer ratio of about 31:1.

16. The stack of substrates of claim 1, wherein said barrier layer is placed in about the middle of said stack of substrates.

17. The stack of substrates of claim 1, wherein said barrier layer results in a lotion gradient value that undergoes a step function.

18. The stack of substrates of claim 1, having a lotion gradient value of less than about 1.3 at a time period selected from the group consisting of one week, one month, and three months after production.

19. The stack of substrates of claim 1, having a lotion gradient value of less than about 1.2 at a time period selected from the group consisting of one week, one month, and three months after production.

20. A container comprising:
a. a container body comprising a wall, said wall defining an article-receiving cavity;
b. an opening located within said wall;
c. a stack of substrates impregnated with a composition, wherein said stack of substrates comprises at least two substrates, each of said at least two substrates having a cross direction dimension and a machine direction dimension; and
d. at least one barrier layer disposed within said stack of substrates.
